(19) United States
(12) Patent Application Publication
(10) Pub. No.: US 2026/0298853 A1
(43) Pub. Date: Oct. 1, 2026

(54) NON-DESTRUCTIVE INSPECTION METHOD FOR LINING TANK, NON-DESTRUCTIVE INSPECTION SYSTEM, AND CONTROL PROGRAM

(71) Applicants: VALQUA, LTD., Tokyo (JP); NATIONAL INSTITUTE OF ADVANCED INDUSTRIAL SCIENCE AND TECHNOLOGY, Tokyo (JP)

(72) Inventors: Takahiro Baba, Machida-city (JP); Yumi Kamiyama, Machida-city (JP); Hirotaka Muto, Machida-city (JP); Syoji Nakamichi, Machida-city (JP); Takeshi Yokoyama, Tokyo (JP); Nao Terasaki, Tsukuba-shi (JP); Yoshitaro Sakata, Tsukuba-shi (JP)

(73) Assignees: VALQUA, LTD., Tokyo (JP); NATIONAL INSTITUTE OF ADVANCED INDUSTRIAL SCIENCE AND TECHNOLOGY, Tokyo (JP)

(21) Appl. No.: 19/476,471

(22) PCT Filed: Apr. 15, 2024
(86) PCT No.: PCT/JP2024/014908

§ 371 Date: Oct. 17, 2025

(30) Foreign Application Priority Data
Apr. 20, 2023 (JP) 2023-069574

(51) Int. Cl. G01N 25/18; G01N 1/44; G01N 25/72

(52) U.S. Cl. CPC G01N 25/18; G01N 1/44; G01N 25/72

(57) ABSTRACT

A non-destructive inspection method includes: a step of heating, by a heat input means (6-1, 6-2, 6-3) of an active thermography inspection system (2), a measurement region (M), toward an outer surface of a can body (24) of a lining tank (12) having a lining layer (26) affixed to an inner surface of the can body via an adhesive layer (28), under a heat input condition including one or both of a heat input distance and a heat input angle; a step of acquiring, by a measurement means (4), at a predetermined measurement distance, a state information indicating a temperature or a temperature change of the measurement region during a cooling period after termination of heating; and a step of analyzing an internal state of the measurement region by an analysis means (8) using the state information to generate an analysis information of the internal state.

### TECHNICAL FIELD

The technology of the present disclosure relates to a non-destructive inspection technology for inspecting a state of a lining tank body based on a state of a temperature distribution on an outer surface and a change of the state of the temperature distribution on the outer surface.

### BACKGROUND ART

A lining tank is, for example, a container having a lining layer affixed to an inner surface of a can body made of metal via an adhesive layer, and has, for example, chemical resistance. In such a lining tank, the lining layer and the adhesive layer may become delaminated due to factors such as aging degradation or environmental conditions during use. Furthermore, through long-term use, a chemical solution inside the lining tank may vaporize and permeate through a degraded lining layer, thereby corroding the can body or the adhesive. Therefore, it is necessary to periodically inspect the internal condition of the lining tank.

As a non-destructive inspection method for a lining tank, a method is known in which a surface temperature distribution caused by non-uniform thermal conductivity resulting from a delaminated state of a lining layer is measured using infrared thermography to detect a delaminated portion of the lining layer (for example, Patent Literature 1).

As a non-destructive inspection method for manufactured articles other than lining tanks, an active thermographic method is known. For example, systems and methods for detecting defects in the vicinity of a surface are known (for example, Patent Literature 2), and systems and methods for non-destructive inspection of a body portion made of a composite material (for example, a composite laminate made of fiber-reinforced plastic) are known (for example, Patent Literature 3).

### CITATION LIST

### Patent Literature

Patent Literature 1: JP 2009-133845 A
Patent Literature 2: JP 2004-530309 A
Patent Literature 3: JP 2019-048369 A

### SUMMARY OF INVENTION

### Technical Problem

In a conventional non-destructive inspection method for a lining tank, a method has been adopted in which the outer surface of the lining tank is heated or cooled such that the absolute value of the temperature difference on the outer surface of the lining tank before and after heating or before and after cooling is 1.5° C. or more in a sound portion where the lining layer is not delaminated. Therefore, as an approach toward practical implementation, a non-destructive inspection method of a contact heating type has been put into practical use, in which a heated gel sheet is brought into contact with the lining tank to ensure a temperature difference of 1.5° C. or more. However, in contact heating using a gel sheet, the gel sheet must be heated, the heated gel sheet must be pressed against the lining tank for a certain period of time, and after removing the gel sheet from the lining tank, measurement and analysis using infrared thermography must be performed, resulting in a problem that the inspection requires time and effort.

When a lining tank is heated using a gel sheet, it is difficult to achieve uniform heating or cooling due to protrusions such as vent holes on the surface of the lining tank, resulting in a problem that it is difficult to enhance inspection accuracy.

An active thermographic method in which an inspection target is heated by thermal radiation has been used for detecting defects in the vicinity of the surface or for detecting defects in non-metallic materials such as composite laminates made of fiber-reinforced plastic. However, such an active thermographic method involving heating by thermal radiation has not been adopted for detecting defects located away from a measurement surface, such as in thick metal members.

Furthermore, in facilities such as plants that utilize lining tanks, a large number of lining tanks are arranged indoors, and the space available for arranging the equipment necessary for inspection is limited. In addition, depending on the application and the scale of the plant, the larger the lining tank becomes, the greater the outer surface area of the can body becomes. Therefore, in inspection using the active thermographic method, it is a problem to perform heating and measurement on a portion to be inspected in an appropriate state.

Since Patent Literatures 1 to 3 do not disclose or suggest such problems, the configurations described in Patent Literatures 1 to 3 cannot solve these problems.

The inventors of the present invention, through computer simulations and inspection experiments using lining tanks or sample pieces, have attempted to implement practical application of the active thermographic method and to improve inspection accuracy and efficiency in non-destructive inspection of lining tanks.

Accordingly, a first object of the technology of the present disclosure is to improve the inspection accuracy of, for example, a degradation state of an adhesive layer or a vicinity of the adhesive layer in a lining tank (such as degradation of the adhesive, delamination, or fluid ingress into a delaminated portion).

A second object of the technology of the present disclosure is to provide, for example, an inspection method for a lining tank that enables efficient non-destructive inspection over a wide range.

### Solution to Problem

To achieve the above-described objects, according to a first aspect of the present disclosure, it includes: a step of heating, by a heat input means of an active thermography inspection system, a measurement region set on a can body, toward an outer surface of the can body of a lining tank having a lining layer affixed to an inner surface of the can body via an adhesive layer, under a heat input condition including one or both of a heat input distance and a heat input angle; a step of acquiring, by a measurement means of the active thermography inspection system, at a predetermined measurement distance, a state information indicating a temperature or a temperature change of the measurement region during a cooling period after termination of heating; and a step of analyzing an internal state of the measurement region by an analysis means of the active thermography inspection system using the state information to generate an analysis information of the internal state.

In the step of heating, the heat input means may heat the can body under the heat input condition which causes an increase in an outer surface temperature of the measurement region in a range of 0.2° C. to 4° C.

In the non-destructive inspection method, the heat input means may include a first heat input device and a second heat input device, and the heat input means may heat the can body under the heat input condition in which an angle formed between a first line of action passing through the center of the measurement region and the first heat input device, and a second line of action passing through the center of the measurement region and the second heat input device, is in a range of 15 degrees to 150 degrees.

In the non-destructive inspection method, the heat input means may include one or more heat input devices, and the heat input means may heat the can body within the measurement region under the heat input condition in which, with reference to an arrangement position or arrangement positions of the one or more heat input devices, the heat input angle with respect to the measurement means is in a range of 7.5 degrees to 75 degrees.

In the non-destructive inspection method, the heat input means may heat the can body under the heat input condition for a duration in a range of 2 seconds to 40 seconds.

In the non-destructive inspection method, it may further include a step of performing a masking process on a part or an entirety of the outer surface of the can body of the lining tank to suppress or prevent at least reflection of infrared rays.

To achieve the above-described objects, according to a second aspect of the present disclosure, it includes: an active thermography inspection system that inspects a lining tank including a can body and a lining layer affixed to an inner surface of the can body via an adhesive layer, wherein the active thermography inspection system including: at least one heat input device that heats a measurement region set on an outer surface of the can body from outside the can body based on a heat input condition including one or both of a heat input distance and a heat input angle; a measurement device that acquires a state information indicating a temperature or a temperature change of the measurement region from outside the lining tank at a predetermined measurement distance during a cooling period after termination of heating; and an analysis device that controls the heat input device and the measurement device, and analyzes an internal state of the measurement region using the state information to generate an analysis information of the internal state.

In the non-destructive inspection system, the analysis device may cause the heat input device to perform heating under the heat input condition in which an outer surface temperature of the measurement region is increased in a range of 0.2° C. to 4° C.

In the non-destructive inspection system, it may include: a first heat input device; and a second heat input device, wherein the heat input angle may be adjusted with respect to the measurement region such that an angle formed between a heating direction of the first heat input device and a heating direction of the second heat input device falls within a range of 15 degrees to 150 degrees.

In the non-destructive inspection system, a heating direction of the heat input device with respect to the measurement region may be adjusted to the heat input angle in a range of 7.5 degrees to 75 degrees with respect to a measurement direction of the measurement device that measures the measurement region.

In the non-destructive inspection system, the analysis device may control the heat input device under the heat input condition in which the lining tank is heated for a duration in a range of 2 seconds to 40 seconds.

To achieve the above-described objects, according to a third aspect of the present disclosure, a control program causes a computer of an active thermography inspection system to implement: a function of causing a heat input means of the active thermography inspection system to heat a measurement region set on a can body of a lining tank including a lining layer affixed to an inner surface of the can body via an adhesive layer, toward an outer surface of the can body, under a heat input condition including one or both of a heat input distance and a heat input angle; a function of causing a measurement means to acquire a state information indicating a temperature or a temperature change of the measurement region at a predetermined measurement distance during a cooling period after termination of heating; and a function of causing an analysis means to analyze an internal state of the measurement region using the state information to generate an analysis information of the internal state.

In the function of causing it to heat, the heat input means may be caused to heat the can body under the heat input condition which causes an increase in an outer surface temperature of the measurement region in a range of 0.2° C. to 4° C.

In the function of causing it to heat, the heat input means may be caused to heat the can body under the heat input condition for a duration in a range of 2 seconds to 40 seconds.

### Advantageous Effects of Invention

According to the technology of the present disclosure, any of the following effects can be obtained.

(1) By adopting the active thermographic method, it is possible to improve the inspection accuracy of a degradation state of an adhesive layer or a vicinity of the adhesive layer in a lining tank, and also to achieve a faster inspection process.

(2) It is possible to efficiently inspect the lining tank over a wide range.

Other objects, features, and advantages of the present invention will become more apparent with reference to the accompanying drawings and embodiments.

### BRIEF DESCRIPTION OF DRAWINGS

FIG. 1 is a diagram that illustrates (A) an example of a non-destructive inspection system according to a first embodiment and its arrangement, and (B) an example of a lining tank.

FIG. 2 is a diagram that illustrates an example of a hardware of an analysis device.

FIG. 3 is a diagram for showing degradation of the lining tank.

FIG. 4 is a diagram that illustrates an example of an inspection method for the lining tank.

FIG. 5 is a diagram for showing a state change in a measurement region.

FIG. 6 is a diagram that illustrates an example of an analysis image.

FIG. 7 is a diagram that illustrates an example of an influence of reflection of infrared rays on a tank surface.

FIG. 8 is a diagram that illustrates an example of a configuration of a non-destructive inspection system according to a second embodiment.

FIG. 9 is a diagram that illustrates an example of an inspection result and a temperature increase amount of the lining tank.

FIG. 10 is a diagram that illustrates an example of an inspection result of the lining tank.

FIG. 11 is a diagram that illustrates an example of an inspection result of the lining tank.

### MODE(S) FOR CARRYING OUT THE INVENTION

### First Embodiment

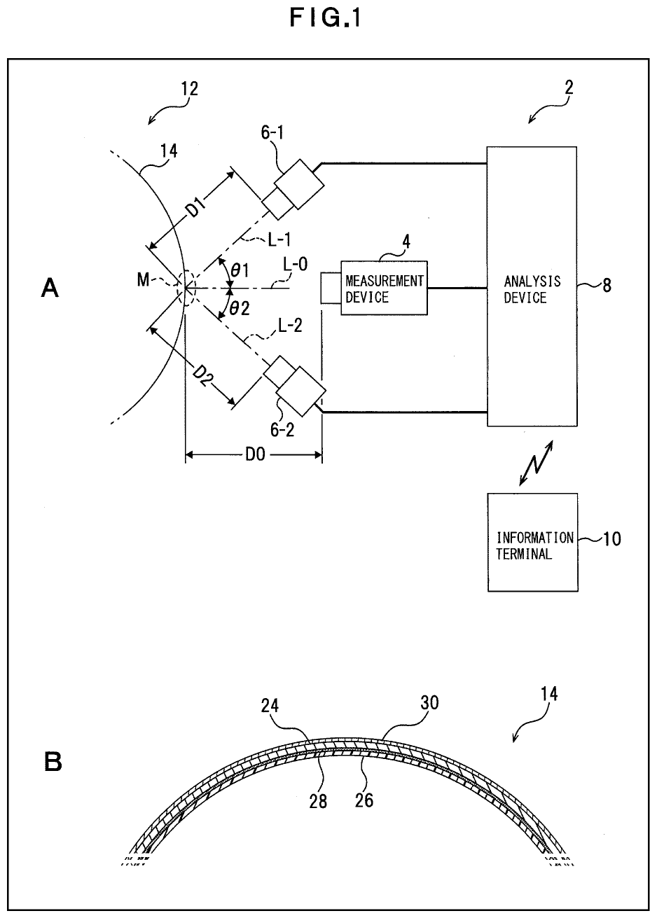

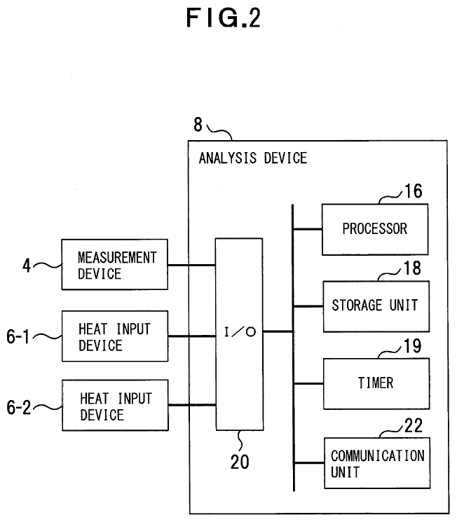

FIG. 1 illustrates an example of a non-destructive inspection system according to a first embodiment and its arrangement, and an example of a lining tank. FIG. 2 illustrates an example of a hardware of an analysis device. The non-destructive inspection system, its arrangement, and the lining tank illustrated in FIG. 1, and the hardware illustrated in FIG. 2 are merely examples, and the technology of the present disclosure is not limited to such a system, arrangement, lining tank, or hardware.

A non-destructive inspection system 2 is arranged outside a lining tank 12 and at a position away from the lining tank 12. The non-destructive inspection system 2 includes, for example, an active thermographic inspection system, and heats an inspection target by applying energy to the inspection target by a heat input means, monitors temperature changes of the inspection target, and evaluates an internal state of the inspection target using the temperature changes. The non-destructive inspection system 2, as the active thermographic inspection system, includes a measurement device 4, first and second heat input devices 6-1 and 6-2, which are examples of the heat input means of the present disclosure (hereinafter simply referred to as “heat input devices 6-1 and 6-2”), and an analysis device 8. The analysis device 8 is connected to the measurement device 4 and the heat input devices 6-1 and 6-2, and communicates with an information terminal 10 in a wired or wireless manner.

The measurement device 4 is arranged in front of a measurement region M of a container wall 14 of the lining tank 12 and is directed toward the measurement region M. A line for measurement L-0 passing through the center of the measurement region M and the measurement device 4 is, for example, orthogonal to a tangent at the center of the curved measurement region M. A separation distance DO from the measurement region M to the measurement device 4 is, as an example of a measurement distance according to the present disclosure, 300 mm to 1200 mm, for example, and preferably 500 mm to 800 mm. When the separation distance DO is 300 mm or more, space can be secured to arrange the heat input devices 6-1 and 6-2 closer to the measurement region M than the measurement device 4. When the measurement device 4 is arranged farther than the heat input devices 6-1 and 6-2, the direct influence of heat from the heat input devices 6-1 and 6-2 on the measurement device 4 is suppressed, thereby reducing the influence on measurement such as difficulty in detecting phase differences in surface temperature. When the separation distance DO is 1200 mm or less, it is possible to suppress a decrease in inspection accuracy due to distance.

The measurement device 4 is, as an example of the measurement means of the present disclosure, an infrared camera, for example, and generates infrared image data of the measurement region M. The measurement device 4 has sensitivity in a wavelength range of, for example, 7.5 μm to 13 μm. The infrared image data represents a surface temperature of the measurement region M. In an image generated based on the infrared image data, temperature differences are represented by colors or gradations.

The measurement device 4 further monitors temperature changes in the measurement region M. That is, the measurement region M periodically or continuously generates infrared image data of the measurement region M to acquire periodic or continuous images of varying spectral radiance. Colors and gradations represented in the infrared image data, as well as the changes of the colors and gradations, constitute an example of state information of the measurement region M.

The measurement region M is, for example, a range of 1 m×1 m. The range of the measurement region M may be determined according to the performance of the non-destructive inspection system 2, the distance between the non-destructive inspection system 2 and the measurement region M, the required accuracy, and the like, and is not limited to the range of 1 m×1 m.

The heat input devices 6-1 and 6-2 are arranged so as to be directed toward the measurement region M. An angle 91 formed between a line of action (first line of action) L-1, which passes through the center of the measurement region M and the heat input device 6-1, and the line for measurement L-0 is, for example, equal to an angle 92 formed between a line of action (second line of action) L-2, which passes through the center of the measurement region M and the heat input device 6-2, and the line for measurement L-0. The value of the angle θ1, θ2, or θ1+θ2 represents an example of heat input angle included in heat input conditions of the present disclosure. The line for measurement L-0 is arranged between the line of action L-1 and the line of action L-2. That is, the heat input devices 6-1 and 6-2 are arranged in bilateral symmetry with respect to the line for measurement L-0, and the measurement region M is heated by the heat input devices 6-1 and 6-2 in bilateral symmetry with respect to the measurement direction of the measurement device 4. The line for measurement L-0 corresponds to the measurement direction of the measurement device 4, the line of action L-1 corresponds to the direction in which the heat input device 6-1 applies heat, and the line of action L-2 corresponds to the direction in which the heat input device 6-2 applies heat.

It is preferable that the angles θ1 and θ2 are in a range of 7.5 degrees to 75 degrees. That is, it is preferable that the total angle (θ1+θ2) of the angles θ1 and θ2 is in a range of 15 degrees to 150 degrees. When the total angle is 15 degrees or more, it is possible to input heat into a relatively large region. When the total angle is 150 degrees or less, the surface of the lining tank 12 can be heated efficiently and uniformly.

The separation distances D1 and D2 from the center of the measurement region M to the heat input devices 6-1 and 6-2 are, for example, in a range of 100 mm to 700 mm, and preferably in a range of 300 mm to 600 mm. These values of the separation distances D1 and D2 represent an example of the heat input distance included in the heat input conditions of the present disclosure. When the separation distances D1 and D2 fall within these ranges, inspection can be performed accurately over a wide range. When the separation distances D1 and D2 are equal, the left-right temperature increase imbalance can be suppressed.

The heat input devices 6-1 and 6-2 are heat sources such as halogen lamps, flash lamps, or lasers, and apply electromagnetic waves that include, for example, any wavelength in a range of 0.5 μm to 20 μm to the measurement region M. The heat input devices 6-1 and 6-2 have an output capable of increasing the outer surface temperature of the measurement region M, for example, in a range of 0.2° C. to 4° C. during a heating time of, for example, a range of 2 seconds to 40 seconds. The wavelength (0.5 μm to 20 μm), heating time (2 seconds to 40 seconds), and temperature increase amount (0.2° C. to 4° C.) are exemplary, and the technique of the present disclosure is not limited to these ranges.

The analysis device 8, as an example of an analysis means according to the present disclosure, is, for example, an infrared thermography computer, acquires infrared image data from the measurement device 4, analyzes the acquired infrared image data, and presents an analysis image as an example of the analysis information of the acquired infrared image data. The analysis device 8, for example, monitors and records an image sequence indicating surface temperatures using the measurement device 4, generates a record of the surface temperature change over time, and evaluates the internal state of the lining tank 12. The analysis device 8 may observe the surface temperature change in detail by capturing individual frames at a plurality of time points during a monitoring period. The analysis device 8 includes a processor 16, a storage unit 18, a timer 19, an input/output (I/O) unit 20, and a communication unit 22.

The processor 16 executes an operating system (OS) and a control program for the inspection system stored in the storage unit 18, controls the measurement device 4 and the heat input devices 6-1 and 6-2, and analyzes the acquired infrared image data to present the analysis image.

The storage unit 18 includes, for example, a read-only memory (ROM) and a random-access memory (RAM). The ROM is a non-volatile memory, stores the operating system and various programs, and is also used to store infrared image data and analysis data. The ROM also stores control information for the measurement device 4 and the heat input devices 6-1 and 6-2. The RAM is a memory that allows high-speed access and is used, for example, for temporary storage of data.

The timer 19 measures time and is used for managing the heating time of the measurement region M, determining the measurement start timing of the measurement device 4, managing the measurement time, and the like.

The input/output unit 20 is connected to the measurement device 4 and the heat input devices 6-1 and 6-2, and is used for inputting information from the measurement device 4 and the heat input devices 6-1 and 6-2, and for outputting information to the measurement device 4 and the heat input devices 6-1 and 6-2.

The communication unit 22 is connected to the information terminal 10 in a wired or wireless manner, and acquires information from the information terminal 10 or outputs information to the information terminal 10.

The lining tank 12 is an example of a measurement target. The container wall 14 of the lining tank 12 includes a can body 24, a lining layer 26, and an adhesive layer 28. The lining tank 12 may be any container in which the lining layer 26 is formed on the inner surface of the can body 24 via the adhesive layer 28 by a resin lining method, and is not limited to any specific type of container.

The material of the can body 24 is not particularly limited as long as it has favorable corrosion resistance, heat resistance, and mechanical strength, and may be, for example, a metal such as stainless steel, carbon steel, or iron. The wall thickness of the can body 24 is, for example, in a range of 1 mm to 12 mm, and preferably in a range of 3 mm to 6 mm. When the thickness of the can body 24 is in a range of 1 mm to 12 mm or a range of 3 mm to 6 mm, the lining tank 12 can be suitably inspected. When the thickness of the can body 24 is 12 mm or less, unevenness in the outer surface temperature of the measurement region M after heating can be suppressed. Furthermore, when the wall thickness of the can body 24 is 12 mm or less, the amount of energy required for heating or cooling can be reduced, enabling stable measurement.

The lining layer 26 is made of a resin having excellent chemical resistance, such as acid resistance and alkali resistance. The resin having excellent chemical resistance may be, for example, a fluororesin. The fluororesin may be, for example, a tetrafluoroethylene-perfluoroalkyl vinyl ether copolymer (PFA), polytetrafluoroethylene (PTFE), tetrafluoroethylene-hexafluoropropylene copolymer (FEP), tetrafluoroethvlene-ethylene copolymer (ETFE), polyvinylidene fluoride (PVDF), polychlorotrifluoroethylene (PCTFE), or chlorotrifluoroethylene-ethylene copolymer (ECTFE). The thickness of the lining layer 26 is, for example, in a range of 1.5 mm to 8 mm. When the thickness of the lining layer 26 is within the range of 1.5 mm to 8 mm, the lining layer 26 can appropriately prevent contact between the can body 24 and the chemical solution inside the tank, and the lining tank 12 can be suitably inspected. Furthermore, when the thickness of the lining layer 26 is 1.5 m or more, unevenness in the outer surface temperature of the measurement region M can be suppressed.

The adhesive layer 28 is formed by solidification of an adhesive. The adhesive used to form the adhesive layer 28 may be, for example, a rubber-based or epoxy-based adhesive. Although the thickness of the adhesive layer 28 is not particularly limited, it is, for example, in a range of 0.1 mm to 2 mm, and preferably in a range of 0.5 mm to 1.5 mm.

The container wall 14 may include a coating film 30 arranged on an outer surface of the can body 24. The coating film 30 is arranged on the outer surface of the container wall 14 and protects the outer surface of the can body 24. The coating film 30 may be, for example, a white paint having high emissivity, and forms a surface with high infrared emissivity and low infrared reflectivity. The coating film 30 may contain, for example, a white pigment mainly composed of titanium oxide, and the emissivity of the coating film 30 is, for example, 0.95. The surface with high infrared emissivity and low infrared reflectivity increases the amount of infrared rays emitted from the container wall 14 due to electromagnetic waves from the heat input devices 6-1 and 6-2, thereby enabling improvement in measurement accuracy.

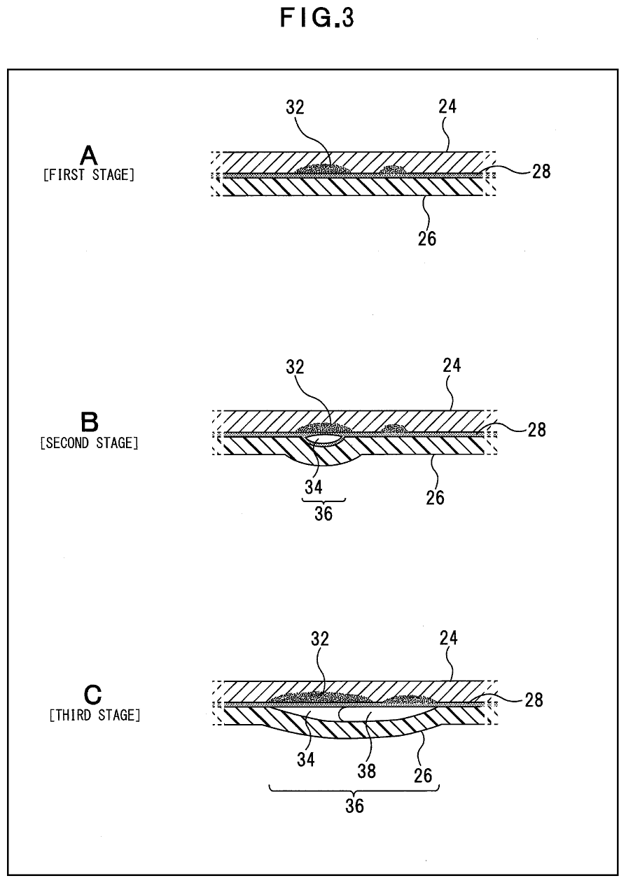

FIG. 3 illustrates an example of degradation of the lining tank.

Although the lining layer 26 has chemical resistance, the lining layer 26 may degrade over time. A chemical solution stored in the lining tank 12, for example in a vaporized state, may permeate through the degraded lining layer 26, corrode the can body 24 or the adhesive layer 28, and generate a corroded portion 32 in the adhesive layer 28 or in the vicinity of the adhesive layer (A of FIG. 3). The vicinity of the adhesive layer is defined, for example, as a boundary portion between the adhesive laver 28 and the can body 24, and as an inner surface portion of the can body 24.

When corrosion progresses, gas that has permeated through the lining layer 26 accumulates in the adhesive layer 28 or in the vicinity of the adhesive layer, causing the lining layer 26 to separate from the can body 24 and forming a delaminated portion 36 (B of FIG. 3). As the corrosion further progresses, part of the gas in a space 34 returns to a liquid state, forming a liquid pool 38 (C of FIG. 3). The gas or liquid between the lining layer 26 and the can body 24 further promotes corrosion of the can body 24 or the adhesive layer 28. The non-destructive inspection system 2 is used to inspect the space 34 or the liquid pool 38 within the container wall 14 of the lining tank 12.

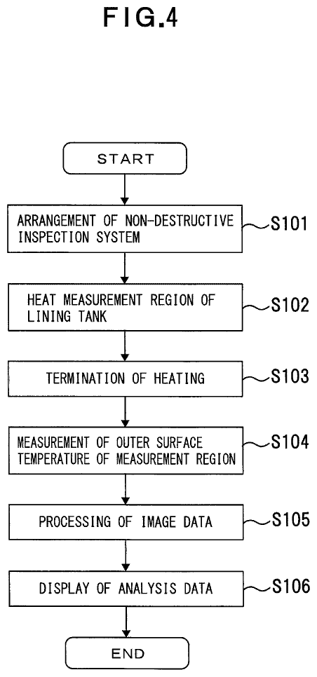

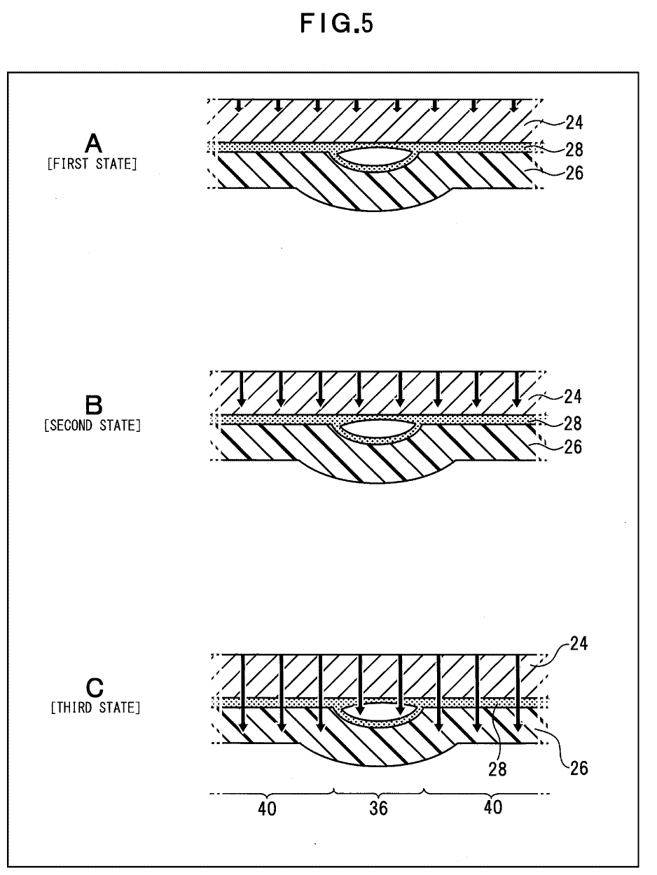

FIG. 4 illustrates an example of an inspection method for the lining tank. FIG. 5 is a diagram for showing a state change in the measurement region. In FIG. 5, arrows represent heat transfer, and the portions to which the arrows are attached indicate that heating has occurred. The inspection method for the lining tank illustrated in FIG. 4 and the state change of the lining tank illustrated in FIG. 5 are merely examples, and the technology of the present disclosure is not limited by such inspection method or state change.

The inspection method for the lining tank 12 is an example of the non-destructive inspection method of the present disclosure. This inspection method includes an arrangement step of the non-destructive inspection system 2, a heating step, a measurement step, an image processing step, and a display step of analysis data. Steps other than the arrangement step of the non-destructive inspection system 2 are executed by a control function of the analysis device 8.

In the arrangement step of the non-destructive inspection system 2, as illustrated in A of FIG. 1, the non-destructive inspection system 2 is arranged with respect to the lining tank 12 to be inspected (S101).

In the heating step, the analysis device 8 operates the heat input devices 6-1 and 6-2, for example, at a set output of 2 kW each for a duration in a range of 2 seconds to 40 seconds, preferably in a range of 3 seconds to 40 seconds, thereby heating the measurement region M of the lining tank 12 (S102). The outer surface temperature of the measurement region M is increased from a preheating temperature by, for example, a range of 0.2° C. to 4° C., preferably a range of 0.3° C. to 3° C. When the operating time of the heat input devices 6-1 and 6-2 (that is, the heating time of the measurement region M) is 2 seconds or more, preferably 3 seconds or more, the outer surface temperature of the measurement region M can be stably increased by adjusting, for example, the arrangement of the non-destructive inspection system 2. When the operating time is 40 seconds or less, it is possible to suppress disturbances of the outer surface temperature caused by heat generation of the heat input devices 6-1 and 6-2 (for example, reflection caused by residual heat of the heat input devices 6-1 and 6-2). When the temperature increase amount of the outer surface temperature is, for example, 0.2° C. or more, preferably 0.3° C. or more, the space 34 or the liquid pool 38 inside the container wall 14 can be easily detected. When the temperature increase amount of the outer surface temperature is, for example, 4° C. or less, preferably 3° C. or less, it is possible to suppress the disturbances of the outer surface temperature caused by heat generation of the heat input devices 6-1 and 6-2. It should be noted that in the inspection method of the embodiment, it is sufficient that the space 34 or the liquid pool 38 inside the container wall 14 can be detected, and the operating time (heating time) and the temperature increase amount are not limited to the aforementioned range of operating time or the aforementioned range of temperature increase amount. The appropriate range of operating time and the appropriate range of temperature increase amount may be expanded by, for example, improvements in the performance of the measurement device 4, improvements in the performance of the heat input devices 6-1 and 6-2 (reduced heat generation), thermal shielding measures, and noise reduction processing of data.

After the lapse of the operating time, the analysis device 8 stops the heat input devices 6-1 and 6-2, thereby terminating the heating (S103). Upon termination of the heating, cooling of the measurement region M is started. As illustrated in A of FIG. 5, immediately after the start of cooling, temperatures of the outer surface and the vicinity of the outer surface of the measurement region M are increased due to heating. The outer surface temperature of the measurement region M is uniform or substantially uniform.

In the measurement step, the analysis device 8 causes the measurement device 4 to image the measurement region M and acquires the captured image data from the measurement device 4. The measurement device 4 acquires thermal images of the surface of the measurement region M in the cooling process during a set measurement time. In other words, the outer surface temperature of the measurement region M is measured by the measurement device 4 (S104). In response to periodic triggers, the measurement device 4 captures the infrared spectral radiance from the surface of the heated lining tank 12 and acquires continuous digital infrared images of the changing spectral radiance on the surface of the measurement region M in the cooling process.

In the measurement step, a thermal state change occurs in the measurement region M. The measurement region M transitions, for example, from the state illustrated in A of FIG. 5 (hereinafter referred to as “first state”) to the state illustrated in B of FIG. 5 (hereinafter referred to as “second state”), and further to the state illustrated in C of FIG. 5 (hereinafter referred to as “third state”). In the transition from the first state to the second state, heat diffuses from the outer surface and the vicinity of the outer surface toward the interior of the measurement region M. Since the heat has not yet reached the adhesive layer 28, the temperature of the outer surface is maintained in a uniform or substantially uniform state. In the transition from the second state to the third state, the diffusing heat reaches the adhesive layer 28, and a difference occurs in heat diffusion depending on the presence or absence of the delaminated portion 36 (or the corroded portion 32). For example, in the delaminated portion 36, heat is less likely to escape into the adhesive layer 28 and the lining layer 26, and therefore, the outer surface temperature of the delaminated portion 36 is higher than the outer surface temperature of a non-delaminated portion 40 other than the delaminated portion 36. In other words, when the measurement region M includes the delaminated portion 36, the outer surface temperature of the measurement region M becomes non-uniform in the middle of the measurement step. Additionally, when the measurement region M includes the corroded portion 32, the outer surface temperature of the measurement region M becomes non-uniform in the middle of the measurement step due to differences in thermal conductivity. Since the measurement device 4 acquires continuous digital infrared images of the measurement region M, it is possible to capture the non-uniform temperature condition of the outer surface caused by the delaminated portion 36 or the corroded portion 32, and to obtain the rate of temporal change in temperature at each location.

The measurement time is set, for example, in a range of 15 seconds to 90 seconds, and preferably in a range of 30 seconds to 60 seconds. When the measurement time is 15 seconds or more, preferably 30 seconds or more, the measurement device 4 can be brought into an imaging state during a transition period in which the measurement region M transitions from the second state to the third state. When the measurement time is 90 seconds or less, preferably 60 seconds or less, it is possible to suppress the measurement time and the overall inspection time. By imaging the measurement region M for a duration in a range of 15 seconds to 90 seconds or a range of 30 seconds to 60 seconds, the measurement region M can be measured appropriately and efficiently, and the delaminated portion 36 or the corroded portion 32 can be detected.

In the image processing step, the analysis device 8 performs analysis processing on the digital infrared image data acquired by the measurement device 4 to obtain analysis data (S105). In the analysis processing, for example, based on surface temperature differences (i.e., a plurality of surface temperatures), a first-order differential image of the surface temperature differences, a phase difference image, the time constant of each pixel, or a reconstructed two-dimensional image thereof may be generated to distinguish differences in thermal conductivity of materials located behind the can body 24. The analysis device 8 may store the digital infrared image data and the analysis data in the storage unit 18. The analysis device 8 is programmed to detect material abnormalities such as interlayer delamination and cavities outside an allowable range, and to specify locations of the material abnormalities. The analysis is performed, for example, in about 60 seconds to 120 seconds.

In the display step of analysis data, the analysis device 8 displays, for example, an analysis image based on the analysis data on a display monitor provided for the analysis device 8 (S106). The analysis device 8 may transmit the analysis data to the information terminal 10, and the information terminal 10 may display the analysis data on a display monitor provided for the information terminal 10.

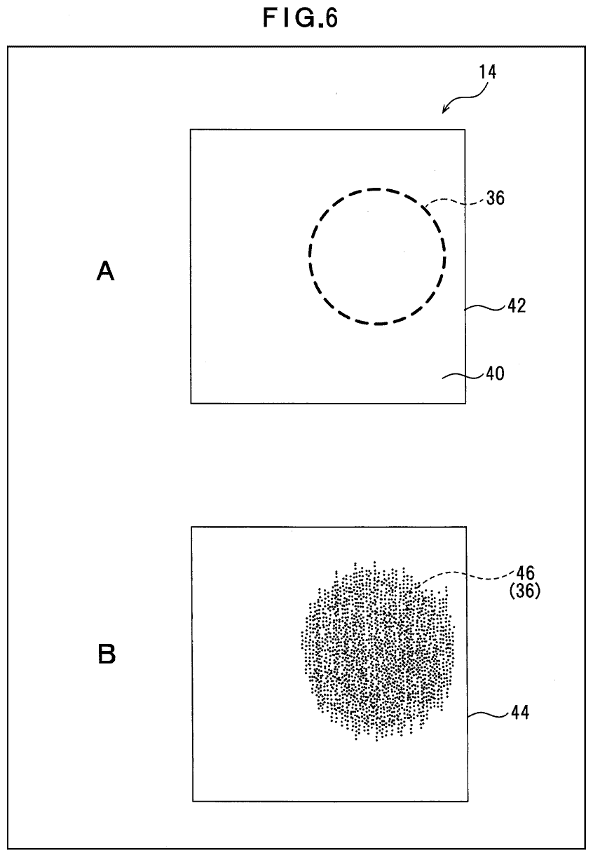

FIG. 6 illustrates an example of the analysis image. In B of FIG. 6, the density of dots represents the temperature, and a denser area of dots indicates a higher temperature.

When the container wall 14 having the delaminated portion 36 at a position indicated by a dashed circle in A of FIG. 6 has been inspected using the non-destructive inspection system 2, an analysis image 44 (phase image) as illustrated in B of FIG. 6 is obtained. The analysis image 44 illustrates that the phase difference varies between the delaminated portion 36 and the non-delaminated portion 40. The non-destructive inspection system 2 enables detection of the delaminated portion 36 based on the phase difference illustrated in the analysis image 44.

### <About Influence on Inspection Due to Reflection on Lining Tank 12>

In the non-destructive inspection system 2, as described above, each of the heat input devices 6-1 and 6-2 and the measurement device 4 are arranged with the predetermined angles 61 and 82, respectively. In addition, the heat input devices 6-1 and 6-2 and the measurement device 4 are arranged at the separation distances D0, D1, and D2 from the lining tank 12, respectively. These angles and separation distances are examples of measuring conditions that adjust a heating range and a heating temperature of the measurement region M and prevent infrared rays unnecessary for a measurement process from being measured.

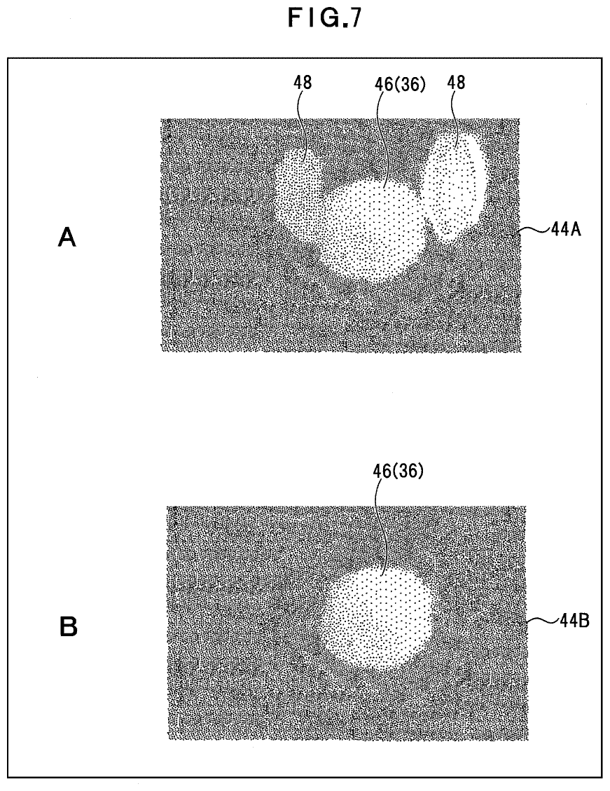

The can body of the lining tank 12 may reflect infrared rays emitted from the heat input devices 6-1 and 6-2 or other heat sources projected onto the can body, depending on, for example, the color or material of its outer surface. When the angles θ1 and θ2 or the separation distances D0, D1, and D2 are not appropriately set, for example, as illustrated, for example, in A of FIG. 7, the measurement device 4 may capture, along with the infrared rays emitted from the heated measurement region M, infrared rays reflected on the surface of the can body. As a result, in an analysis image 44A, in addition to a delaminated portion 46 caused by poor adhesion of a lining sheet, a pseudo-delaminated portion 48 caused by residual heat of the heat input devices 6-1 and 6-2 may be formed.

In contrast, in the non-destructive inspection system 2 of the present disclosure, as illustrated in B of FIG. 7, by appropriately setting the heat input conditions of the heat input devices 6-1 and 6-2 and the measurement distance of the measurement device 4, it is possible to measure only the delaminated portion 46 caused by poor adhesion of the lining sheet in an analysis image 44B.

Note that the heat input conditions and the measurement distance for preventing the reflection of unnecessary infrared rays for inspection may also be set in consideration of factors such as the size of the diameter of the can body of the lining tank 12, the curvature of the can body surface, and the reflectance of the can body surface. In addition, as a means to prevent the capture of unnecessary infrared rays, masking means for suppressing or preventing the reflection of the infrared rays may be applied to the surface of the lining tank 12 either in place of, or in conjunction with, the heat input conditions and the measurement distance.

Characteristic features, advantages, and modifications, etc. of the first embodiment are listed below.

(1) By appropriately arranging the non-destructive inspection system 2 in accordance with the arrangement disclosed in the present disclosure and by operating the non-destructive inspection system 2 appropriately under the conditions disclosed in the present disclosure, it is possible to generate a surface temperature difference caused by degradation of the lining tank 12 on the outer surface of the lining tank 12. By analyzing the surface temperature difference on the outer surface of the lining tank 12, it is possible to analyze the degradation state of the adhesive layer 28 or the vicinity of the adhesive layer.

(2) In conventional inspection methods using gel sheets, the measurement of minor abnormalities that do not accompany visual abnormalities on the side of the lining layer 26 has been unstable. For example, in conventional inspection methods, the measurement of abnormalities such as degradation of the adhesive without any delamination of the lining layer 26 has been unstable. In contrast, by performing the above-described non-destructive inspection using the non-destructive inspection system 2 of the present disclosure, inspection accuracy can be improved. Minor abnormalities that do not accompany visual abnormalities on the side of the lining layer 26 can be observed.

(3) In conventional inspection methods, it has been necessary, for example, to press a heated gel sheet against a can body for a fixed period of time, resulting in a large number of man-hours and significant unevenness in heating. In contrast, with the non-destructive inspection system 2 of the present disclosure, the excitation of the measurement region M by the heat input devices 6-1 and 6-2 is performed for a duration in a range of several seconds to several tens of seconds, enabling rapid evaluation of a relatively large area. The number of man-hours is reduced, and the time required for a single measurement can be shortened from approximately 10 minutes to, for example, approximately 3 minutes. For example, the lining tank 12 with a volume of 1 m³ can be measured in, for example, 1.5 hours or less.

(4) Since the lining tank 12 is heated in a non-contact manner, the measurement region M can be suitably heated even when there are protrusions on the outer surface of the lining tank 12, thereby suppressing a decrease in inspection accuracy.

(5) Tn the first embodiment, the number of the heat input devices 6-1 and 6-2 is two. However, the number of the heat input devices 6-1 and 6-2 may be one, or three or more. For example, the number of the heat input devices 6-1 and 6-2 may be an even number, and the same number of the heat input devices 6-1 and 6-2 may be arranged right and left or up and down of the measurement device 4. The heat input devices 6-1 and 6-2 may also be evenly arranged around the measurement device 4.

(6) The lining tank 12 may not include the coating film 30. When the infrared emissivity of the outer surface of the lining tank 12 is low or the infrared reflectivity of the outer surface is high, for example, a masking material such as a masking tape or masking sheet with high emissivity may be applied to the outer surface of the measurement region M to form a surface having high infrared emissivity and low infrared reflectivity. The masking material may be, for example, a tape or sheet made of vinyl chloride, and the emissivity of the masking material is, for example, 0.95. By applying the masking material, the amount of infrared rays emitted from the container wall 14 by electromagnetic waves from the heat input devices 6-1 and 6-2 increases, thereby enabling improvement in measurement accuracy.

(7) The measurement device 4 is not limited to a device having sensitivity in the wavelength range of 7.5 μm to 13 μm. The measurement device 4 may be a cooled infrared camera having sensitivity in a middle infrared (3 μm to 5 μm), or an uncooled or cooled infrared camera having sensitivity in a long infrared (8 μm to 14 μm).

(8) The non-destructive inspection of the first embodiment is a pulse-type inspection method in which heat input is performed once to the measurement region M and measurement is performed after the heat input. However, the non-destructive inspection may be other inspection methods such as a lock-in method.

(9) in the non-destructive inspection of the first embodiment, measurement is started after the termination of heating. However, a certain non-measurement period may be set between the termination of heating (S103) and the outer surface temperature measurement (S104). In addition, although measurement is started after the termination of heating, initial measurement data within a certain period from the start of measurement may be excluded from the analysis. By setting the non-measurement period or excluding the initial measurement data, it is possible to exclude surface temperature differences unrelated to degradation occurring in the first state (A of FIG. 5) or the second state (B of FIG. 5) from the analysis. In other words, mixing of noise in analysis can be suppressed.

(10) In the non-destructive inspection of the first embodiment, the inner surface of the measurement region M may be in contact with a liquid such as a chemical solution, or may be in contact with a gas such as air or vaporized gas. In the verification by the inventors, it has be confirmed that degradation can be detected regardless of the liquid contact or the gas contact.

### Second Embodiment

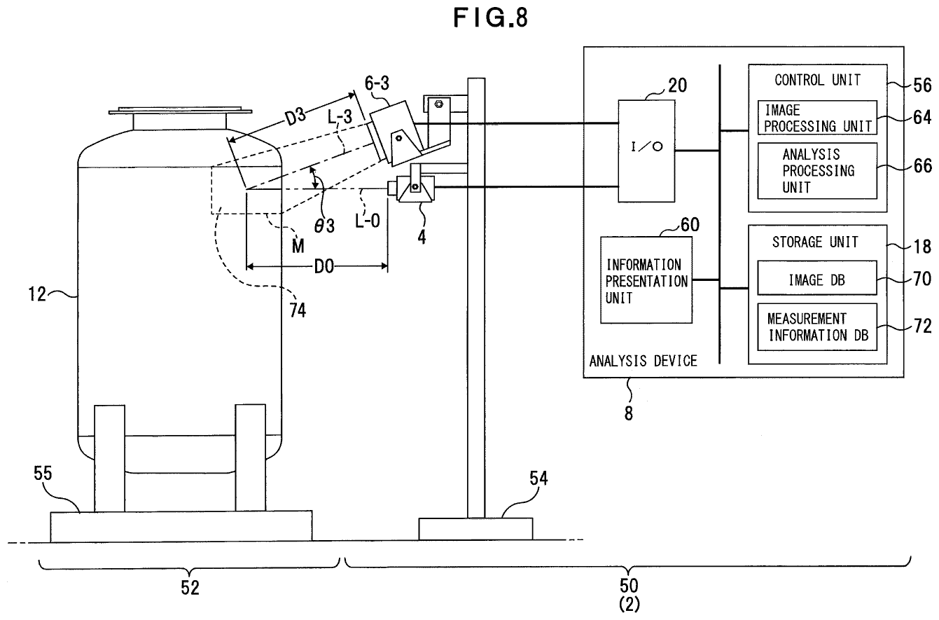

FIG. 8 illustrates an example of a configuration of a non-destructive inspection system 50 according to a second embodiment. The configuration illustrated in FIG. 8 is an example, and the technology of the present disclosure is not limited to the configuration. In addition, in FIG. 8, the same reference signs are used for components identical to those in FIG. 1, and detailed descriptions thereof are omitted.

The non-destructive inspection system 50 illustrated in FIG. 8 illustrates a means for heating the measurement region M of the lining tank 12, which is an inspection target 52, by using, for example, a single heat input device 6-3 and inspecting a degradation state of adhesion between the lining sheet and the adhesive layer 28 inside the tank, based on the state information of the temperature thereof. The measurement device 4 and the heat input device 6-3 are arranged, for example, in a vertically aligned manner with a supporting means 54 arranged adjacent to the lining tank 12. The supporting means 54, for example, may support the measurement device 4 and the heat input device 6-3 together as support targets, or may support each of the support targets individually.

The supporting means 54 only needs to be configured such that the height, angle, and other parameters of the measurement device 4 and the heat input device 6-3 can be adjusted relative to the measurement region M of the tank, and may further be configured to be movable along the outer peripheral surface of the can body. With the supporting means 54, the measurement device 4 and the heat input device 6-3 can be set on measurement conditions in which the separation distances DO and D3, and the angle 83 are set relative to the measurement region M.

In addition, a holding means 55 for holding the lining tank 12 is provided for the side of the inspection target 52. The holding means 55 may include, for example, an arm that holds a portion of the bottom or side surface of the can body of the tank, and may further include a moving or rotating function for moving the measurement region M of the tank toward the line for measurement L-0 on the measurement device 4 or the line of action L-3 on the heat input device 6-3.

The analysis device 8 includes, for example, the storage unit 18, a control unit 56, and an information presentation unit 60.

The control unit 56 is a functional unit that performs arithmetic processing based on a program stored in the storage unit 18 by the processor 16, and functions, for example, as an image processing unit 64 and an analysis processing unit 66.

The image processing unit 64 is an example of the functional unit that executes the aforementioned image processing step and performs processing of digital infrared image data acquired from the measurement device 4 through the input/output unit 20.

The analysis processing unit 66 is an example of a functional unit that executes an analysis processing step and performs analysis processing on the digital infrared image data processed by the image processing unit 64 to generate the analysis data thereof.

The storage unit 18 may store, for example, an image database (hereinafter referred to as “image DB”) 70 and a measurement information database (hereinafter referred to as “measurement information DB”) 72.

The image DB 70 stores, for example, digital infrared image data acquired by the measurement device 4, as well as processed images, analysis data, etc. processed by the control unit 56, together with information for specifying the measurement timing and the measurement region M.

The measurement information DB 72 stores, for example, information on inspection conditions such as heat input conditions, such as the angle and heating time of the heat input device 6-3, and inspection conditions such as the line for measurement L-0 on the measurement device 4, and identification information for identifying the measurement region M set on a portion of the can body surface of the lining tank 12. The measurement information DB 72, for example, may also be associated with the image DB 70 via linking or the like, so that images and analysis data corresponding to the identification information or measurement conditions can be read.

The information presentation unit 60 is an example of a functional unit that executes the above-described display step of the analysis data, and may be configured of a display means such as a monitor or the communication unit 22 that notifies the analysis data to a user terminal device.

In addition, in the non-destructive inspection system 50, by performing similar processing to in the first embodiment, it is possible to inspect the state of the lining tank body and the degradation state of the adhesive layer of the lining tank or the vicinity of the adhesive layer.

Furthermore, in the inspection process, a masking tape 74 is affixed to the surface of the lining tank 12, at least within the range of the measurement region M. The affixing of this masking tape is an example of the masking process in the present disclosure, and is intended to at least suppress or prevent infrared reflection on the surface of the can body. The masking tape 74 used herein may be, for example, black or a color close to black, or may be of a dark color or a low-gloss type that lowers infrared reflectance, as long as the reflectance of the surface is low.

In addition, as described above, the masking tape 74 may be made of a material or color with high emissivity.

By affixing the masking tape 74, it is possible to prevent the measurement device 4 from capturing something other than the infrared rays emitted from the heated measurement region M. As a result, the degree of freedom of the separation distance D3 and the angle θ3 of the heat input device 6-3 can be increased, thereby enhancing the adaptability of the non-destructive inspection process to the arrangement environment of the lining tank 12.

It should be noted that the means for reducing the reflectivity of the infrared rays is not limited to the masking tape 74. A sheet member such as a black sheet member may be arranged on the measurement region M of the can body, or a paint capable of exhibiting the same function may be applied.

### <Effects of Second Embodiment>

According to such a configuration, the following effects can be obtained.

(1) Effects similar to those of the first embodiment can be obtained.

(2) By applying a masking process that suppresses or prevents infrared reflection at least on the measurement region M, it is possible to suppress the influence of the arrangement environment of the lining tank 12, and thereby improve the workability, work efficiency, and inspection accuracy of the inspection.

### Example 1

The non-destructive inspection system 2 according to Example 1 has a configuration similar to the non-destructive inspection system 2 according to the first embodiment. A description of the identical components is omitted. The non-destructive inspection system 2 according to Example 1 particularly includes the following configuration.

### [Configuration of Non-destructive Inspection System 2]

Basic system: IrNDT system (manufactured by FineSensing Corp.)
Heat input devices 6-1 and 6-2: halogen lamps (two units arranged)
   (set output: equivalent to 2.0 kW per unit)

The lining tank 12 having the delaminated portion 36 with a diameter of 120 mm is inspected by the non-destructive inspection system 2 according to Example 1. The configuration of the lining tank 12 is as follows.

### [Configuration of Lining Tank 12]

Can body 24: stainless steel (SUS304) with a thickness of 6 mm
Lining layer 26: polytetrafluoroethylene (PTFE) with a thickness of 3 mm
Adhesive layer 28: cemedine 575F (with a thickness of approximately 1 mm)
Outer surface: white coating

The arrangement of the non-destructive inspection system 2 is as follows.

### [Arrangement of Non-destructive Inspection System 2]

Camera distance (D0): approximately 300 mm, approximately 500 mm, approximately 800 mm, or approximately 1200 mm
Lamp distance (D1, D2): approximately 300 mm, approximately 600 mm, or approximately 700 mm
Lamp angle (θ1+θ2): set in a range of 0 degrees to 180 degrees

The inspection conditions for the non-destructive inspection are as follows.

### [Inspection Conditions]

Heating time: set in a range of 1 second to 25 seconds
Cooling time (measuring time): 60 seconds

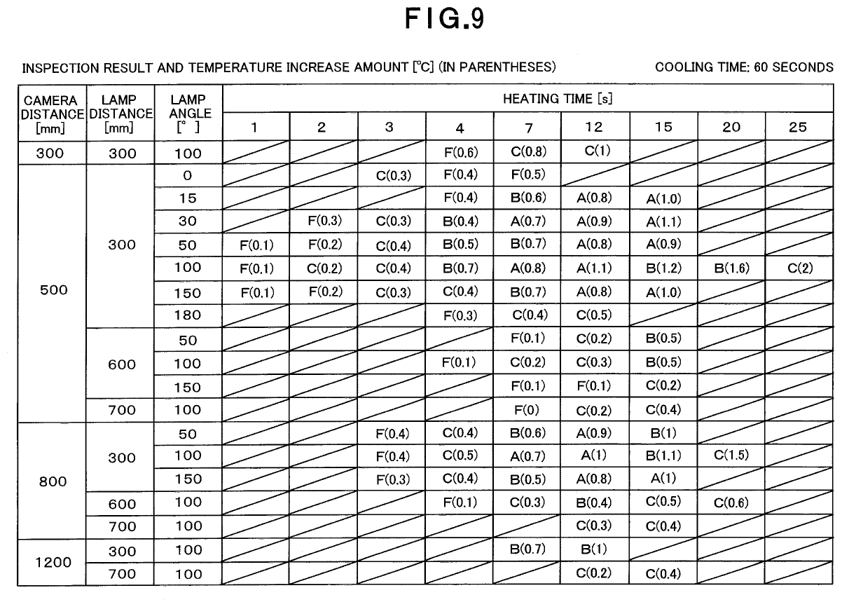

FIG. 9 illustrates an example of an inspection result and a temperature increase amount of the lining tank. The inspection result and the temperature increase amount illustrated in FIG. 9 are merely examples. When the configuration or arrangement of the non-destructive inspection system 2, the configuration of the lining tank 12, or the like differs, different inspection results and temperature increase amounts may be obtained. In addition, different inspection results and temperature increase amounts may also be obtained depending on factors such as heat shielding measures or noise reduction processing.

The inspection results are indicated as “A”, “B”, “C”, and “F”. “A” indicates that the inspection accuracy is excellent, and “B” indicates that the inspection accuracy is good. “C” includes not only cases where the inspection accuracy is average, but also cases where “unevenness” is detected to prompt a detailed inspection or re-inspection of the lining tank 12. Additionally, “C” includes cases where disturbances of the outer surface temperature that do not interfere with the inspection (for example, reflection caused by residual heat of the heat input devices 6-1 and 6-2) are detected. “F” includes not only cases where the delaminated portion 36 or the liquid pool 38 cannot be detected, but also cases where the disturbances of the outer surface temperature that interfere with the inspection are detected.

The numerical values in parentheses illustrated in FIG. 9 represent the temperature increase amount [unit: ° C.] during the heating step. The temperature increase amount is the average temperature increase amount of the measurement region M and is measured by a thermographic camera arranged separately from the non-destructive inspection system 2.

From the inspection results illustrated in FIG. 9, the following findings are obtained.
It is found that when the temperature increase amount during the heating step is 0.3° C. or more, inspection results of grade “C” or higher can generally be obtained. Additionally, when the temperature increase amount is 0.2° C., a plurality of conditions is confirmed under which the inspection result is grade “C”.
It is found that a heating time in a range of 7 seconds to 15 seconds is generally favorable, and that longer heating times result in degraded inspection results due to reflections from the heat input devices 6-1 and 6-2. It is also found that inspection results under heating times exceeding 15 seconds have potential for improvement through heat shielding measures, noise reduction processing, etc.
It is found that when the camera distance is approximately 500 mm or approximately 800 mm, inspection results of grade “C” or higher are more likely to be obtained. Additionally, it is found that even when the camera distance is approximately 300 mm or approximately 1200 mm, inspection results of grade “C” or higher can be obtained through adjustments of other conditions.
It is found that when the camera distance is approximately 500 mm, the outer surface temperature of the measurement region M can be stably secured during a heating time of 3 seconds or more.
When the camera distance is approximately 500 mm and the lamp distance is approximately 300 mm, inspection results of grade “C” or higher can generally be obtained within a lamp angle range of 15 degrees to 150 degrees and a heating time range of 3 seconds to 15 seconds. Additionally, inspection results of grade “C” or higher can be obtained at a lamp angle of 100 degrees and within a heating time range of 2 seconds to 25 seconds.
It is found that the lamp distance can generally be set in a range of 300 mm to 700 mm, and that a range of 300 mm to 600 mm is generally favorable.

In view of the inspection in Example 1, the usefulness of the numerical ranges described in the embodiments has been confirmed.

It is found that in the non-destructive inspection system 2 and the non-destructive inspection according to Example 1, inspection results of grade “C” or higher can be obtained even when the temperature increase amount in the heating step is less than 2° C. In addition, it is found that defects located away from the measurement surface of thick metal members or the like can be inspected by an active thermography method. As a result, the range of options for heating methods and thermography methods has dramatically expanded, thereby advancing the non-destructive inspection of the lining tank 12.

### Example 2

The non-destructive inspection system 2 according to Example 2 has a configuration similar to the non-destructive inspection system 2 according to Example 1. A description of the identical components is omitted.

By the non-destructive inspection system 2 according to Example 2, the lining tank 12 having a configuration similar to the lining tank 12 according to Example 1 is inspected. A description of the identical components is omitted. The delaminated portion 36 of the lining tank 12 according to Example 2 is as follows. The delamination process is defined by the thickness of the space 34.

### [Types of Delaminated Portion 36]

Type (1): diameter 70 mm, delamination distance 1 mm
Type (2): diameter 120 mm, delamination distance 1 mm
Type (3): diameter 70 mm, delamination distance 2 mm
Type (4): diameter 120 mm, delamination distance 5 mm

The arrangement of the non-destructive inspection system 2 is as follows.

### [Arrangement of Non-destructive Inspection System 21

Camera distance (D0): approximately 800 mm
Lamp distance (D1, D2): approximately 300 mm
Lamp angle (θ1+θ2): approximately 45 degrees

The inspection conditions for the non-destructive inspection are as follows.

### [Inspection Conditions]

Heating time: 7 seconds
Cooling time (measuring time): 60 seconds

As a result of inspecting the lining tank 12 by the non-destructive inspection system 2 according to Example 2, the delaminated portions 36 of types (1) to (4) can be successfully identified. It should be noted that the delaminated portions 36 of types (1) to (4) all correspond to a second stage of tank degradation illustrated in B of FIG. 3.

### Example 3

The non-destructive inspection system 2 according to Example 3 has a configuration similar to the non-destructive inspection system 2 according to Example 1. A description of the identical components is omitted.

The lining tank 12 having the delaminated portion 36 with a diameter of 120 mm is inspected by the non-destructive inspection system 2 according to Example 1. Except for the application of a masking tape in place of white coating, the lining tank 12 has a configuration similar to the lining tank 12 according to Example 1. A description of the identical components is omitted. The masking tape is a tape made of vinyl chloride with a thickness of 0.1 mm and an emissivity of 0.95.

The arrangement of the non-destructive inspection system 2 is as follows.

### [Arrangement of Non-destructive Inspection System 2]

Camera distance (D0): approximately 500 mm
Lamp distance (D1, D2): approximately 300 mm, approximately 600 mm, or approximately 700 mm
Lamp angle (θ1+θ2): approximately 100 degrees

As a result of the inspection, it is found that when the cooling time is 60 seconds and the heating time is in a range of 4 seconds to 20 seconds, inspection results of grade “C” or higher can generally be obtained. By applying a masking tape and adjusting the arrangement and inspection conditions of the non-destructive inspection system 2, it is possible to inspect the lining tank 12 which is unpainted.

### Example 4

The non-destructive inspection system 2 according to Example 4 has a configuration similar to the non-destructive inspection system 2 according to Example 1, except for the heat input devices 6-1 and 6-2. A description of the identical components is omitted. The configuration of the heat input devices 6-1 and 6-2 is as follows. In the non-destructive inspection system 2 according to Example 4, two halogen lamps are arranged at the arrangement position of the heat input device 6-1, and two halogen lamps are arranged at the arrangement position of the heat input device 6-2.

### [Configuration of Non-destructive Inspection System 2]

Heat input devices 6-1 and 6-2: halogen lamps (four units arranged)
   (set output: equivalent to 2.0 kW per unit)

The lining tank 12 having the delaminated portion 36 with a diameter of 120 mm is inspected by the non-destructive inspection system 2 according to Example 4. Except for the absence of white coating and masking tape, the lining tank 12 has a configuration similar to the lining tank 12 according to Example 1. A description of the identical components is omitted.

The arrangement of the non-destructive inspection system 2 is as follows.

### [Arrangement of Non-destructive Inspection System 21

Camera distance (D0): approximately 500 mm
Lamp distance (D1, D2): approximately 300 mm, approximately 400 mm
Lamp angle (θ1+θ2): approximately 100 degrees

The inspection conditions for the non-destructive inspection are as follows.

### [Inspection Conditions]

Heating time: set in a range of 7 seconds to 25 seconds
Cooling time (measuring time): 60 seconds

When the heating time is 15 seconds or more, the temperature increase amount is 1° C. or more, and inspection results of grade “C” or higher can be obtained. Even in cases where both white coating and masking tape are absent and the emissivity of the outer surface is low, the lining tank 12 can be inspected by adjusting the number of the heat input devices 6-1 and 6-2.

It should be noted that the adjustment of the number of the heat input devices 6-1 and 6-2 may also be performed in the inspection of the lining tank 12 having a white coating or masking tape. For example, under the following arrangement and inspection conditions of the non-destructive inspection system 2, the temperature increase amount is 1° C. to 1.1° C., and the delaminated portion 36 having the diameter of 120 mm can be detected.

### [Arrangement of Non-destructive Inspection System 21

Camera distance (D0): approximately 600 mm or approximately 800 mm
Lamp distance (D1, D2): approximately 300 mm
Lamp angle (θ1+θ2): approximately 30 degrees, approximately 80 degrees, or approximately 100 degrees

### Example 5

Example 5 has a configuration similar to the non-destructive inspection system 50 according to the second embodiment. A description of the identical components is omitted. The non-destructive inspection system 50 according to Example 5 particularly includes the following configuration.

### [Configuration of Non-destructive Inspection System 50]

As the heat input device 6-3, a halogen lamp (set output: 2.0 kW) is used. This halogen lamp is of a type that is not provided with a reflector on the peripheral portion of a light irradiation portion.
The lining tank 12 is subjected to the following processing.

The following measurement conditions are adopted.

(1) Measurement Condition 1: the coating film 30 is applied to the outer surface of the can body, and a black tape is affixed to the measurement region M as a masking process.

(2) Measurement Condition 2: the coating film 30 is applied to the outer surface of the can body, but no black tape is affixed.

(3) Measurement Condition 3: no coating film 30 is applied to the outer surface of the can body, and a white tape is affixed to the measurement region M as a masking process.

Other configurations are similar to those in Example 1 described above.

The following conditions are set in the non-destructive inspection system 50.

### [Arrangement of Non-Destructive Inspection System 50]

Camera distance (D0): set in a range of approximately 270 mm to 410 mm
Lamp distance (D3): set in a range of approximately 300 mm to 430 mm
Lamp angle (93): approximately 20 degrees

The inspection conditions for the non-destructive inspection are as follows.

### [Inspection Conditions]

Heating time: 12 seconds
Cooling time (measuring time): 60 seconds

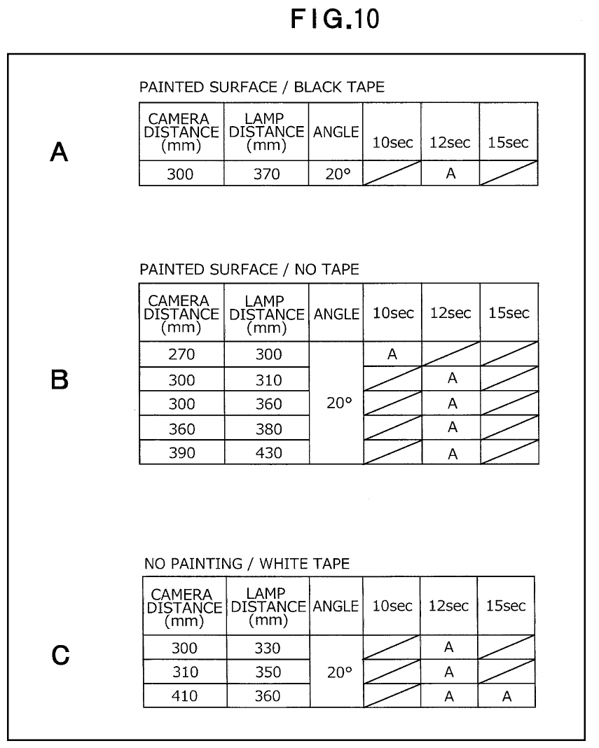

From the inspection results illustrated in FIG. 10, the following findings are obtained.
In the measurement under Measurement Condition 1, as illustrated in A of FIG. 10, for example, when the measurement region M is heated at a lamp distance of 370 mm and measured with a separation at a camera distance of 300 mm, a measurement result of grade “A” can be obtained at a heating time of 12 seconds.
In the measurement under Measurement Condition 2, as illustrated in B of FIG. 10, for example, when heating is performed at a lamp distance of 300 mm and the camera distance is 270 mm, a measurement result of grade “A” can be obtained at a heating time of 10 seconds. Furthermore, when heating is performed at a lamp distance in a range of 310 mm to 430 mm and the camera distance is in a range of 300 mm to 390 mm, a measurement result of grade “A” can be obtained at a heating time of 12 seconds.
In the measurement under Measurement Condition 3, as illustrated in C of FIG. 10, for example, when heating is performed at a lamp distance of 330 mm or 350 mm and the camera distance is 300 mm or 310 mm, a measurement result of grade “A” can be obtained at a heating time of 12 seconds. Furthermore, when heating is performed at a lamp distance of 360 mm and the camera distance is 410 mm, a measurement result of grade “A” can be obtained at a heating time of 12 seconds or 15 seconds.
From these results, it is evident that even when only one heat input device 6-3 is used and the angle θ3 relative to the measurement device 4 is small, it is possible to sufficiently heat the outer surface of the measurement region M by setting a predetermined heating time, thereby enabling the inspection of the internal condition of the lining tank.

### Example 6

Example 6 has a configuration similar to the non-destructive inspection system 50 according to the second embodiment. A description of the identical components is omitted. The non-destructive inspection system 50 according to Example 6 particularly includes the following configuration.

### [Configuration of Non-Destructive Inspection System 50]

As the heat input device 6-3, a halogen lamp (set output: 2.0 kW) is used. This halogen lamp is of a type provided with a reflector.
The lining tank 12 is subjected to the following processing.

The following measurement conditions are adopted.

(1) Measurement Condition 4: the coating film 30 is applied to the outer surface of the can body, a black tape is affixed to the measurement region M as a masking process, and the heat input angle θ3 is fixed at 20 degrees.

(2) Measurement Condition 5: no coating film 30 is applied to the outer surface of the can body, a black tape is affixed, and the measurement distance is fixed at 500 mm.

Other configurations are similar to those in Example 5 described above.

### [Inspection Conditions]

Heating time: set in a range of 2 seconds to 15 seconds
Cooling time (measuring time): 60 seconds

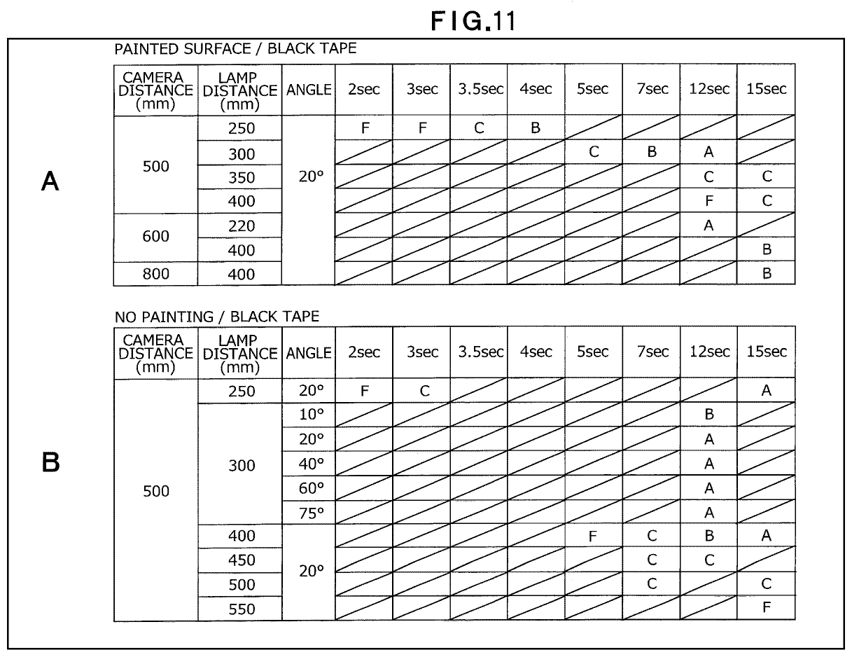

From the inspection results illustrated in FIG. 11, the following findings are obtained.
In the measurement under Measurement Condition 4, as illustrated in A of FIG. 11, for example, when the camera distance is 500 mm and the measurement region M is heated at a lamp distance of 250 mm, a result of grade “F” can be obtained at a heating time of 2 seconds or 3 seconds, and a measurement result of grade “C” or higher can be obtained at a heating time of 3.5 seconds or more. In addition, it is found that when the camera distance is fixed at 500 mm and the lamp distance is increased to 300 mm, 350 mm, and 400 mm, the heating time required to obtain a measurement result of grade “C” or higher is delayed to 5 seconds, 12 seconds, and 15 seconds or more, respectively.
Moreover, in the measurement process under Measurement Condition 4, when the measurement region M is heated at a lamp distance of 220 mm or 400 mm, and the camera distance is 600 mm, a measurement result of grade “B” or higher can be obtained at 12 seconds or 15 seconds or more.
Furthermore, when the measurement region M is heated at a lamp distance of 400 mm, and the camera distance is 800 mm, a measurement result of grade “B” or higher can be obtained at 15 seconds or more.

From these results, it is found that as the heat input device 6-3 is closer to the measurement region M, the heating efficiency is higher, and inspection results can be obtained more quickly.
In the measurement under Measurement Condition 5, as illustrated in B of FIG. 11, for example, when the measurement region M is heated at a lamp distance of 250 mm, a measurement result of grade “F” can be obtained at a heating time of 2 seconds, while a measurement result of grade “C” or higher can be obtained at a heating time of 3 seconds or 15 seconds.
In addition, when the lamp distance is 300 mm and the angle θ3 is set to 10 degrees, 20 degrees, 40 degrees, 60 degrees, or 75 degrees to heat the measurement region M, a measurement result of grade “B” or higher can be obtained at a heating time of 12 seconds at all the degrees of the angle θ3.
Furthermore, when the lamp distance is 400 mm, 450 mm, or 500 mm and the angle θ3 is set to 20 degrees to heat the measurement region M, a measurement result of grade “C” or higher can be obtained at a heating time of 7 seconds.
Furthermore, when the lamp distance is 550 and the angle θ3 is set to 20 degrees to heat the measurement region M, a measurement result of grade “F” is obtained even after 15 seconds.

From the results under Measurement Conditions 4 and 5 described above, it is evident that when a heating process is performed using a single lamp, the internal state of the lining tank can be inspected regardless of the magnitude of the angle θ3 by applying a masking process with a black tape. In addition, it is found that when the distance to the measurement region M increases, for example, exceeds 550 mm, the measurement region M cannot be sufficiently heated or requires a heating process of 15 seconds or more.

Modifications of the configuration of the present disclosure described above are listed below.

(1) The non-destructive inspection systems 2 and 50 according to the examples may be modified in a similar manner to the modifications described in the embodiments.

(2) In the above examples, the IrNDT system is adopted as the basic system. However, the basic system is not limited to the IrNDT system. For example, another system such as the thermal lock-in analysis system Smart-LI (manufactured by JFE Techno-Research Corporation) may be used. Furthermore, the non-destructive inspection systems 2 and 50 of the embodiments may be configured with the IrNDT system or another system.

As described above, the most preferred embodiments, etc. of the present disclosure have been described. However, the technical scope of the present disclosure is not limited to the above description. It is of course understood that various modifications and changes can be made by those skilled in the art based on the gist of the invention recited in the claims or disclosed in the description, and such modifications and changes are naturally included within the scope of the present disclosure.

### INDUSTRIAL APPLICABILITY

The technology of the present disclosure can be used for inspection of the lining tank 12 and is useful.

### REFERENCE SIGNS LIST

2, 50 Non-destructive inspection system
4 Measurement device
6-1, 6-2, 6-3 Heat input device
8 Analysis device
10 Information terminal
12 Lining tank
14 Container wall
M Measurement region
16 Processor
18 Storage unit
19 Timer
20 Input/output unit
22 Communication unit
24 Can body
26 Lining layer
28 Adhesive layer
30 Coating film
32 Corroded portion
34 Space
36, 46 Delaminated portion
38 Liquid pool
40 Non-delaminated portion
44 Analysis image
48 Pseudo-delaminated portion
52 Inspection target
54 Supporting means
55 Holding means
56 Control unit
60 Information presentation unit
64 Image processing unit
66 Analysis processing unit
70 Image DB
72 Measurement information DB

1. A non-destructive inspection method for a lining tank, the method comprising:
a heating step of heating a measurement region set on an outer surface of the lining tank by heat generation of a heat input means;
a step of acquiring, by a measurement means of an active thermography inspection system, a state information indicating a temperature or a temperature change of the measurement region during a cooling period after termination of heating; and
a step of analyzing, by an analysis means of the active thermography inspection system, the state information to generate an analysis information indicating an internal state of the lining tank, wherein
the heat input means and the measurement means are arranged, so that an angle formed between a line of action passing through a center of the measurement region and the heat input means, and a line for measurement passing through the center of the measurement region and the measurement means is in a range of approximately 7.5 degrees to 75 degrees or a range of 7.5 degrees to 75 degrees,
a measurement distance between the lining tank and the measurement means is approximately 300 mm to 1200 mm or 300 mm to 1200 mm, and
a separation distance between the lining tank and the heat input means is approximately 100 mm to 700 mm or 100 mm to 700 mm.

2. (canceled)

3. The non-destructive inspection method according to claim 1, wherein
the heat input means includes a first heat input device and a second heat input device,
the heat input means is arranged, so that an angle formed between a first line of action, which is the line of action, passing through the center of the measurement region and the first heat input device, and a second line of action, which is the line of action, passing through the center of the measurement region and the second heat input device, is in a range of approximately 15 degrees to 150 degrees or a range of 15 degrees to 150 degrees,
the measurement distance between the lining tank and the measurement means is approximately 500 num to 800 mm or 500 mm to 800 mm, and
the separation distance between the lining tank and the heat input means is approximately 300 mm to 600 mm or 300 mm to 600 mm.

4-14. (canceled)

15. The non-destructive inspection method according to claim 3, wherein, in the heating step, a heating time is approximately 7 seconds to 15 seconds or 7 seconds to 15 seconds to cause a temperature of the measurement region to increase in a range of approximately 0.2° C. to 4° C. or a range of 0.2° C. to 4° C.

16. The non-destructive inspection method according to claim 15, wherein
at least one of the heat input devices is a halogen lamp, and
the lining tank has a can body of stainless steel with a thickness of approximately 6 mm or 6 mm and a lining layer formed on an inner surface of the can body via an adhesive layer.
